(19) United States
(12) Patent Application Publication
(10) Pub. No.: US 2014/0318397 A1
(43) Pub. Date: Oct. 30, 2014

(54) SYSTEMS AND METHODS FOR IMPLEMENTING DIGITAL OFFSET LITHOGRAPHIC PRINTING TECHNIQUES WITH A PLURALITY OF INTERMEDIATE TRANSFERS

(71) Applicant: XEROX CORPORATION, Norwalk, CT (US)

(72) Inventors: Steven R. MOORE, Pittsford, NY (US); Chu-heng LIU, Penfield, NY (US)

(73) Assignee: XEROX Corporation, Norwalk, CT (US)

(21) Appl. No.: 13/874,465

(22) Filed: Apr. 30, 2013

(51) Int. Cl. B41F 35/00

(52) U.S. Cl. CPC B41F 35/002
USPC 101/147; 101/450.1

(57) ABSTRACT

A system and method are provided for optimizing a multi-color variable digital data lithographic image forming system by controlling characteristics of one or more individual color inks to maximize ink transfer of a particular color ink layer onto the surface of an image receiving medium substrate, or onto other color ink layers deposited on the surface of the image receiving medium substrate when producing digital output images, including multi-color digital output images, with a proposed variable digital offset lithographic architecture. Ink characteristics and ink transfer parameters are particularly optimized in the proposed variable digital data lithographic systems to promote high efficiency ink transfer from an ink donor surface to an ink receiver surface in order that excessive amounts of untransferred ink do not remain on the ink donor surface requiring extensive cleaning of the reimageable surface in the image forming system between cycles of a multi-color ink system.

### BACKGROUND

1. Field of Disclosed Subject Matter

This disclosure relates to systems and methods for optimizing a multi-color variable data digital offset lithographic system by controlling characteristics of one or more individual color inks or relative donor/receiver surface characteristics to maximize ink transfer of a particular color ink layer onto a receiver surface including the surface of an image receiving medium substrate, or onto other color ink layers deposited on the receiver surface when forming digital output images, including multi-color digital output images, with a proposed variable digital data offset lithographic image forming system architecture.

2. Related Art

Lithography is a common method of printing or marking images on an image receiving medium. Depending on a configuration of a conventional lithography system, a highly-viscous lithographic ink may be transferred directly to a substrate of image receiving medium, such as paper, or may be transferred to an intermediate transfer surface or member for further transfer to the image receiving medium substrate. This latter configuration is referred to as an offset lithographic printing system. An intermediate transfer member is often comprised of a surface that is covered with a conformable coating or sleeve that constitutes the intermediate transfer surface, and that can conform to the surface topography of the image receiving medium substrate. Using the intermediate transfer member with the conformable surface may provide an ability within the system to compensate for image receiving media substrates that may have surface peak-to-valley depths that are somewhat greater than the surface peak-to-valley depths than could reasonably be accommodated by an etched imaging plate. Sufficient pressure is used to transfer the image from the intermediate transfer member to the image receiving medium substrate. The image receiving medium substrate is pinched between the intermediate transfer member and an impression cylinder that provides pressure against the intermediate transfer member to provide a transfer nip. At the transfer nip, the inked image pattern deposited on the surface of the intermediate transfer member is transferred to the image receiving medium substrate.

Conventional lithographic and offset lithographic printing techniques use plates that are permanently patterned (etched), and are, therefore, generally considered to be useful only when printing a large number of copies of the same image in long print runs, such as for magazines, newspapers, and the like. These conventional processes are generally not considered amenable to creating and printing a new pattern from one page to the next because, according to previously known methods, removing and replacing of individual printing plates, including on a print cylinder, would be required in order to change images. For these reasons, conventional lithographic techniques cannot accommodate true high speed variable data printing in which the images change from impression to impression, for example, as in the case of digital printing systems.

The lithography process has the advantage, however, of providing very high quality printing at least in part due to the comparatively high pigment loading and color gamut of the lithographic inks. The lithographic inks typically have a high color pigment content in a range of 20-70% by weight. Based on this advantage and a comparatively low cost of the inks, a desire arose to find some manner by which to implement variable data lithographic image forming.

Among the disadvantages encountered in attempting to modify conventional lithographic systems for variable digital data printing, even as configurations of digital data printing devices have emerged, is with respect to a relatively low transfer efficiency of the inks from the imaging surfaces of particular imaging members to intermediate transfer surfaces and to image receiving media substrates. Common conventional lithographic printing processes operate with ink transfer efficiencies on the order of approximately 50%, i.e., about half of the ink that is applied to the imaging surface actually transfers to the image receiving medium substrate. In conventional lithographic image forming, in a situation where the images do not change across large print runs, this relatively low transfer efficiency is not generally considered to be a drawback. On the other hand, proposed variable digital data lithographic image forming schemes require higher transfer efficiencies in order to produce high quality variable digital data images (with no ghosting) while not requiring significant modifications in traditional imaging surface cleaning systems and methods. Previously proposed systems by which attempts have been made to modify conventional lithographic process to support variable digital data image forming have fallen short in a number of ways including in providing relatively high transfer efficiencies for individual images, greater than 90% for example, to reduce ink waste that must be stripped off between image re-formation and the associated costs.

### SUMMARY OF THE DISCLOSED EMBODIMENTS

In order to address the shortfalls in adapting conventional lithographic image forming techniques to variable digital data image forming, U.S. Patent Application Publication No. 2012/0103212 A1 (the 212 Publication) published May 3, 2012 and based on U.S. patent application Ser. No. 13/095,714, which is commonly assigned and the disclosure of which is incorporated by reference herein in its entirety, proposes systems and methods for providing variable digital data lithographic and offset lithographic printing or image receiving medium marking. The systems and methods disclosed in the 212 Publication are directed to improvements on various aspects of previously-attempted variable data imaging lithographic marking concepts based on variable patterning of a particularly-formulated dampening fluid, to achieve effective truly variable digital data lithographic printing.

According to the 212 Publication, a comparatively smooth reimageable surface is provided on an imaging member, which may be a drum, plate, cylinder, belt or the like. The reimageable surface may be formed of a relatively thin layer over a mounting layer, a thickness of the relatively thin layer being selected to balance printing or marking performance, durability and manufacturability.

The 212 Publication describes, in requisite detail, an exemplary variable digital data lithographic image forming system 100 such as that shown, for example, in FIG. 1. A general description of the exemplary system 100 shown in FIG. 1 is provided here. Additional details regarding individual components and/or subsystems shown in the exemplary system 100 of FIG. 1 may be found in the 212 Publication.

As shown in FIG. 1, the exemplary system 100 may include an imaging member 110. The imaging member 110 in the embodiment shown in FIG. 1 is a cylinder, but this exemplary depiction should not be read in a manner that precludes the imaging member 110 being a plate or a belt, or of another known configuration. The imaging member 110 is used to apply an inked image to an image receiving medium substrate 114 at a transfer nip 112. The transfer nip 112 is produced by an impression cylinder 118, as part of an image transfer mechanism 160, exerting pressure in the direction of the imaging member 110. The exemplary system 100 may be used for producing images on a wide variety of image receiving medium substrates. The 212 Publication also explains the wide latitude of marking (printing) materials that may be used including marking materials with pigment densities greater than 10% by weight. Higher densities of pigment content, however, render these particular “inks” highly viscous.

The exemplary system 100 includes a dampening fluid subsystem 120 for uniformly wetting the reimageable surface of the imaging member 110 with a particularly-formulated dampening fluid. A purpose of the dampening fluid subsystem 120 is to deliver a layer of dampening fluid, generally having a uniform and controlled thickness, to the reimageable surface of the imaging member 110. The dampening fluid may comprise water optionally with small amounts of isopropyl alcohol or ethanol added to reduce surface tension as well as to lower evaporation energy necessary to support subsequent image forming including laser patterning, as will be described in greater detail below. Small amounts of certain surfactants may be added to the dampening fluid as well. It should be recognized that, although the dampening fluid is described in the 212 Publication as being water-based, it should not be considered to be so limited.

Once the dampening fluid is metered onto the reimageable surface of the imaging member 110, a thickness of the dampening fluid may be measured using a sensor 125 that may provide feedback to control the metering of the dampening fluid onto the reimageable surface of the imaging member 110 by the dampening fluid subsystem 120.

Once a precise and uniform amount of dampening fluid is provided by the dampening fluid subsystem 120 on the reimageable surface of the imaging member 110, an optical patterning subsystem 130 may be used to selectively form a latent image in the uniform dampening fluid layer by image-wise patterning the dampening fluid layer using, for example, laser energy. The reimageable surface of the imaging member 110 should ideally be designed to absorb most of the laser energy emitted from the optical patterning subsystem 130 close to its surface to minimize energy wasted and to minimize lateral spreading of heat in order to maintain a high spatial resolution capability. Alternatively, an appropriate radiation sensitive component may be added to the dampening fluid to aid in the absorption of the incident radiant laser energy. While the optical patterning subsystem 130 is described above as being a laser emitter, it should be understood that a variety of different systems may be used to deliver the optical energy to pattern the dampening fluid.

The mechanics at work in the patterning process undertaken by the optical patterning subsystem 130 of the exemplary system 100 are described in detail with reference to FIG. 5 in the 212 Publication. Briefly, the application of optical patterning energy from the optical patterning subsystem 130 results in image-wise evaporation of the layer of dampening fluid.

Following patterning of the dampening fluid layer by the optical patterning subsystem 130, the patterned layer over the reimageable surface of the imaging member 110 is presented to an inker subsystem 140. In the system described in the 212 Publication, as depicted in FIG. 1, the inker subsystem 140 is used to apply a uniform layer of a single color of ink over the patterned layer of dampening fluid on the reimageable surface of the imaging member 110.

The cohesion and viscosity of the inked image pattern residing on the reimageable surface of the imaging member 110 may be modified by a number of mechanisms. One such mechanism may involve the use of a rheology (complex viscoelastic modulus) control subsystem 150. The rheology control system 150 may form a partial crosslinking core of the ink on the reimageable surface, for example, to increase the cohesion of the ink relative to adhesion of the ink to the reimageable surface. Ink pre-conditioning mechanisms may include optical or photo curing, heat curing, drying, or various forms of chemical curing. Cooling may be used to modify rheology as well via multiple physical cooling mechanisms, as well as via chemical cooling.

The inked image is then transferred from the reimageable surface of the imaging member 110 to an image receiving medium substrate 114 using a transfer subsystem 160. The transfer occurs as the image receiving medium substrate 114 is passed through the transfer nip 112 between the imaging member 110 and an impression roller 118 such that the ink on the reimageable surface of the imaging member 110 is brought into physical contact with the image receiving medium substrate 114. Careful control of the temperature and pressure conditions at the transfer nip 112 may allow transfer efficiencies for the pre-conditioned ink from the reimageable surface of the imaging member 110 to the image receiving medium substrate 114 to be controlled. While it is possible that some dampening fluid may also wet the image receiving medium substrate 114, the volume of such a dampening fluid will be minimal, and will rapidly evaporate or be absorbed by the image receiving medium substrate 114.

Following the transfer of the inked image from the reimageable surface of the imaging member 110 to the image receiving medium substrate 114, any residual ink and/or residual dampening fluid must be removed from the reimageable surface, preferably without scraping or wearing the surface. An air knife 175 may be employed, for example, to remove residual dampening fluid from the reimageable surface. It is anticipated, however, that some amount of ink residue may remain. Removal of such remaining ink residue may be accomplished through use of some form of cleaning subsystem 170. The 212 Publication describes details of such a cleaning subsystem 170 including at least a first cleaning member such as a sticky or tacky member in physical contact with the reimageable surface of the imaging member 110. The sticky or tacky member may be used to remove the residual ink and any remaining small amounts the dampening fluid. The sticky or tacky member may then be brought into contact with a smooth cylinder to which residual ink may be transferred, the residue ink being subsequently stripped from the smooth cylinder by, for example, a doctor blade.

The 212 Publication details that, once cleaned, the reimageable surface of the imaging member 110 is again presented to the dampening fluid subsystem 120 by which a fresh layer of dampening fluid is supplied to the reimageable surface of the imaging member 110, and the process is repeated.

According to the above proposed architecture, variable digital data lithography has attracted attention in producing truly variable digital images in a lithographic image forming system.

Separate systems have been proposed for incorporating the above architecture into a conventional offset lithographic system. U.S. patent application Ser. No. 13/494,098 to Jia et al. (the 098 Application), entitled “Systems And Methods For Implementing Digital Offset Lithographic Printing Techniques,” filed Jun. 12, 2012, which is commonly assigned and the disclosure of which is incorporated herein by reference in its entirety, discloses examples of proposed multi-color variable data lithographic systems. The exemplary multi-color variable data lithographic system concepts disclosed in the 098 may include multiple individual color modules based on an objective of maximum reuse of a conventional lithographic architecture. FIG. 2 illustrates an exemplary embodiment of a four-color variable digital data lithographic image forming system, including multiple exemplary modified offset lithographic printing modules for maximum reuse of known offset lithographic systems. As shown in FIG. 2, multiple individual modules may include ink donor cylinders 210,220,230,240; ink forming cylinders 212,222,232,242; imaging member cylinders 214,224,234,244; and impression cylinders 218,228,238,248. Each module may provide a single ink color to the intermediate transfer member 256 according to the system details shown in FIG. 1 (certain of the details of the particular single-color ink modules being removed for clarity). Image conditioning or partial curing may be provided between each of the individual modules to the as-applied inked images on the surface of the image transfer member 256. Each of the individual modules may be used to deposit a different color of an identical or variable inked image on the intermediate transfer member 256. The multi-layer inked image on the image transfer member 256 is then transferred to an image receiving medium substrate 280 through a transfer nip formed between an opposing pair of impression cylinders 257,258 associated with the intermediate transfer member 256.

An additional cleaning unit 290 may be provided downstream of the transfer nip to clean residual ink and/or other debris from the surface of the intermediate transfer member 256 after the inked image is transferred to the image receiving medium substrate 280 at the transfer nip. The cleaning unit 290 may include a pressure cylinder 292, a sticky or tacky cylinder 294 and a smooth cylinder 296 or other configurations of relevant cleaning components.

Those of skill in the art will recognize that differing configurations of module elements, including, for example, providing multiple individual intermediate transfer members for the transfer of inked images to image receiving medium substrates employing differing numbers of individual modules with the same or different color inks may be included.

In the above-discussed examples of single-color variable digital data lithographic modules and multi-color variable digital data lithographic image forming systems, certain challenges arise that were not of concern in conventional lithographic systems. These challenges involve principally the need to increase levels of ink transfer efficiency from the reimageable surface to the intermediate transfer member and from the intermediate transfer member to the image receiving medium substrate for the reasons discussed above. In conventional lithographic printing, the inks are comparatively viscous and the inks tend to split at the image transfer nips leaving often as much ink with the ink donor surface as is transferred to the ink receiver surface at each nip. This challenge is exacerbated in the production of multi-level inked images where ink is transferred from the ink donor surface onto an already inked receiver surface.

It would be advantageous to optimize ink characteristics and ink transfer parameters in the proposed variable digital data lithographic image forming systems to promote high efficiency ink transfer from an ink donor surface to an ink receiver surface in order that, for example, excessive amounts of untransferred ink do not remain on the ink donor surface requiring extensive cleaning in the image forming system between cycles of a multi-color ink system.

Exemplary embodiments of the systems and methods according to this disclosure control characteristics of the inks and relative ink transfer parameters to promote high efficiency ink transfer in variable digital data lithographic image forming systems and devices.

Exemplary embodiments promote high ink transfer efficiencies in inked image transfer from the reimageable surface of the imaging member to the intermediate transfer body and then from the intermediate transfer body to the image receiving medium substrate.

Exemplary embodiments that include image on image transfer optimize the process of multiple layers of ink transfer from a plurality of reimageable surfaces in a plurality of individual ink color modules to an intermediate transfer member by necessarily controlling the transfer characteristics of the ink in order to (1) obtain highest levels of ink transfer, and (2) reduce potential for back transfer from the intermediate transfer member to the imaging members and their reimageable surfaces in the plurality of individual ink color modules comprising the multi-color image on image transfer system.

Exemplary embodiments may control individual colors of ink transfer by including combinations of a donor surface and a receiver surface in which a surface texture of the receiver surface is comparatively rougher than a surface texture of the donor surface thereby aiding in higher efficiency ink transfer between those surfaces.

In embodiments, when transferring multiple ink layers, a relationship between the tack (viscosity measure) between the first layer of ink and second or subsequent layers of inks must be according to a particular relationship as described in detail in this disclosure to promote highest levels of ink transfer while reducing potential for retacking of ink to the reimageable surface of the imaging member.

Exemplary embodiments modify the ink transfer scheme used in conventional offset lithography in which ink is transferred from one surface to another and typically splits in a condition where approximately half of the ink is transferred to the receiver surface and half of the ink remains with the donor surface. In embodiments, the disclosed schemes control characteristics (cohesiveness) of the ink to limit the possibility/likelihood of the ink splitting when being transferred from the donor surface to the receiver surface or from the donor surface to an ink layer already deposited on the receiver surface.

Exemplary embodiments may provide that almost all of the formed ink images on the reimageable surface of the imaging member and on the intermediate transfer member, e.g., in excess of 90%, are transferred to a next receiver surface.

Exemplary embodiments may include a unique multi-ink, single reimageable surface configuration for a variable digital data offset lithographic module for producing multi-color images on image receiving substrates that is particularly adaptable to the disclosed schemes. The color images on the receiver surface may be pre-conditioned or pre-cured between individual color applications in the unique multi-ink module to avoid back transfer.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and systems and methods for optimizing a multi-color variable digital data offset lithographic image forming systems by controlling characteristic of a plurality of individual color inks to maximize ink transfer onto a substrate or onto other color ink layers in producing multi-color digital output images with a proposed variable digital data offset lithographic image forming system architecture will be described, in detail, with reference to the following drawings, in which:

FIG. 1 illustrates a schematic representation of a proposed variable digital data lithographic image forming system;

FIG. 2 illustrates an exemplary embodiment of a four-color variable digital data lithographic image forming system including multiple exemplary modified offset lithographic printing modules for maximum reuse of known offset lithographic system components that may be optimized according to the disclosed systems and methods;

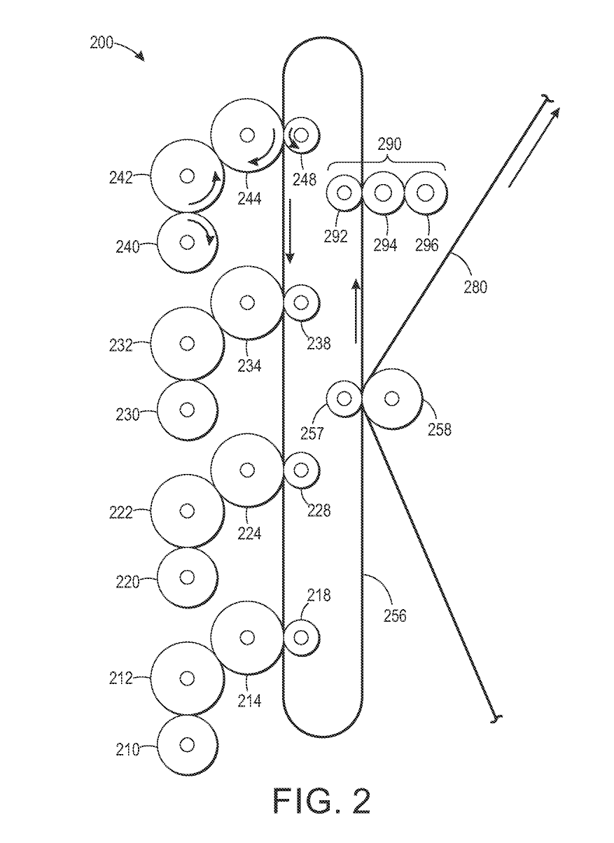

FIG. 3 provides a first illustrative example of the ink transfer phenomenon that the systems and methods according to this disclosure address;

FIG. 4 provides a second illustrative example of the ink transfer phenomenon that the systems and methods according to this disclosure address;

FIG. 5 illustrates an exemplary embodiment of a unique multi-color module for a variable digital data lithographic image forming system according to this disclosure;

FIG. 6 illustrates a block diagram of a control system for controlling characteristics and functions of variable digital data lithographic image forming according to this disclosure; and

FIG. 7 illustrates a flowchart of an exemplary method for controlling characteristics and functions of variable digital data lithographic image forming according to this disclosure.

### DETAILED DESCRIPTION OF THE DISCLOSED EMBODIMENTS

The systems and methods for optimizing a multi-color variable digital data offset lithographic image forming system by controlling characteristics of a plurality of individual color inks to maximize ink transfer onto a substrate or onto other color ink layers in producing multi-color digital output images with a proposed variable digital data offset lithographic image forming system architecture according to this disclosure will generally refer to this specific utility or function for those systems and methods. Exemplary embodiments described and depicted in this disclosure should not be interpreted as being specifically limited to any particular configuration of the described elements, or as being specifically directed to any particular intended use. Any advantageous combination of schemes for modifying viscosity and/or rheology of a particular lithographic ink composition to promote high efficiency ink transfer is contemplated. Additionally, various configurations of one or more of an ink donor surface, an ink receiving surface, an imaging member, an intermediate transfer member and/or an image receiving medium substrate, as those components or elements may be understood to be employed in a variable digital data lithographic image forming systems, particularly where differences in surface textures of the ink donor surface and the ink receiver surface promote high transfer efficiencies for the various inks are contemplated to be included in the description below.

Specific reference, for example, to various configurations of offset lithographic printing devices, or proposed variable digital data lithographic image forming systems should not be considered as being limited to any particular configuration of those respective devices, as described and those references are intended to refer globally to a class of devices and systems that carry out what are generally understood as lithographic printing functions as those functions would be familiar to those of skill in the art.

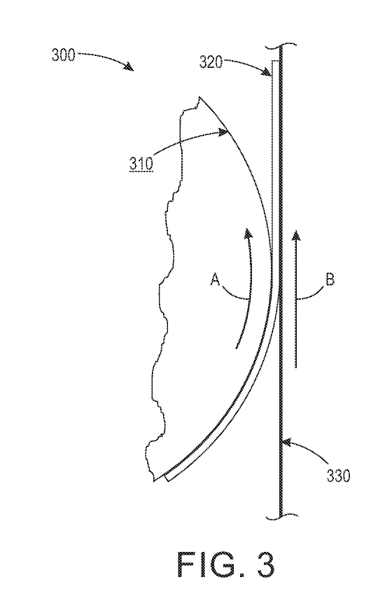

FIG. 3 provides a first illustrative example 300 of the ink transfer phenomenon that the systems and methods according to this disclosure address. As shown in FIG. 3, when transferring a single layer of ink 320 from an ink donor surface 310 (rotating generally in direction A) to an ink receiver surface 330 (moving generally and coincidentally in direction B), an adhesion force between the donor surface 310 and the ink layer 320 may be controlled to be less than a cohesion force of the ink in the ink layer 320. This control may be provided by varying at least one of (1) a composition of the ink, (2) a physical configuration of the donor surface, or (3) a preparation of the donor surface with release agents, among other techniques. Additionally, when transferring the single layer of ink 320 from the ink donor surface 310 to the ink receiver surface 330, the adhesion force between the donor surface 310 and the ink layer 320 may also be controlled to be less than an adhesion force between the ink layer 320 and the receiver surface 330. In addition to the above variables, these forces may be controlled by, for example, varying the relative surface topology of the donor surface and the receiver surface in a manner that the receiver surface is relatively “rougher” than the donor surface.

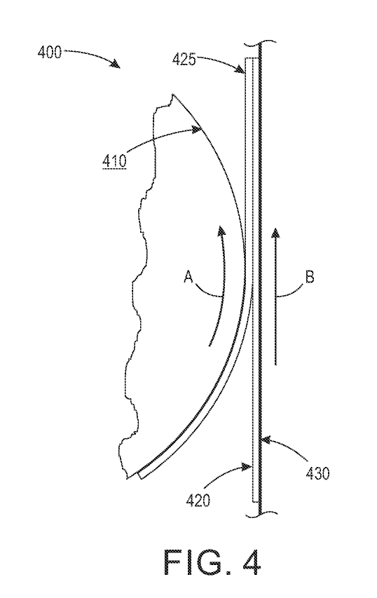

FIG. 4 provides a second illustrative example 400 of the ink transfer phenomenon that the systems and methods according to this disclosure address. As shown in FIG. 4, the control of the relative characteristics of the multiple inks and of the donor and receiver surfaces become somewhat more complicated when transferring multiple layers of inks 420,425 from an ink donor surface 410 (rotating generally in direction A) to an ink receiver surface 430 (moving generally and coincidentally in direction B). Controlling of transfer of the first ink layer 420 from a donor surface 410 to a receiver surface 430 may be according to the illustration and description above with respect to FIG. 3. When transferring a second or subsequent ink layer 425 from the donor surface 410 to receiver surface 430 over the first ink layer 420, or a plurality of previously deposited ink layers already disposed on the receiver surface 410, the relative forces may be controlled as follows:
(a) An adhesion force between the donor surface 410 and the second or subsequent ink layer 425 may be controlled to be less than a cohesion force of the ink in the second or subsequent ink layer 425.
(b) An adhesion force between the donor surface 410 and the second or subsequent ink layer 425 may be controlled to be less than an adhesion force between the second or subsequent ink layer 425 and the first ink layer 420.
(c) An adhesion force between the donor surface 410 and the second or subsequent ink layer 425 may be controlled to be less than a cohesion force of the ink in the first ink layer 420.
(d) An adhesion force between the donor surface 410 and the second or subsequent ink layer 425 may be controlled to be less than an adhesion force between the receiver surface 430 and the first ink layer 420.

As with the example shown in, and discussed above regarding, FIG. 3, control of the relative forces may be provided by varying at least one of (1) the varying compositions of the first and second or subsequent inks, (2) the physical configuration of the donor surface, (3) the preparation of the donor surface with release agents, among other techniques, and/or (4) the varying of the relative surface topologies of the donor and receiver surfaces in a manner that the receiver surface is relatively “rougher” than the donor surface.

Absent the systems and methods according to this disclosure, which promote increased relative transfer efficiencies in the proposed systems from donor surfaces to receiver surfaces, too much residual ink may be left on the donor surfaces (1) requiring excessive cleaning and/or (2) producing excessive residual ink waste.

Unlike a xerographic image forming process in which a varying electrical bias can be used to move charged toner images in a desired direction, the transfer of the lithographic inked images from the donor surface to the receiver surface requires consideration of the complex interactions discussed above. The control of the respective forces may promote inked image transfer from a reimageable surface of an imaging member to a surface of an intermediate transfer member and from the surface of the intermediate transfer member to a surface of an image receiving medium substrate, both relevant transfers being accomplished with high efficiency and with sufficient latitude.

Further, the control of the respective forces is intended to prevent relevant back transfer. There may be four layers of ink in a fourth transfer nip to the intermediate transfer member making the image at that point in the image forming process most susceptible to ink splitting and back transfer. With an understanding that the variable digital data lithographic image forming process is a rheology dominated process, the balances of relative adhesions and cohesions play a critical role promoting high efficiency ink transfer. The simple rule is:
Adhesion (ink to donor surface)< Adhesion (ink to receiving surface); and
Adhesion (ink to donor surface)< Cohesion (ink)
   One important fact is that the cohesion of the ink layer may be proportional to the viscosity of the ink layer and inversely proportional to a thickness of the ink layer.

Separately, a material for the intermediate transfer member may be carefully chosen. The material may first be chosen to promote release of the multi-layer inked image at the final transfer to the image receiving medium substrate. The selection of material may be, for example, from the classes of materials commonly known as silicones or fluoro-silicones, and those marketed under the trade name Viton®.

In addition, the ink layer/intermediate transfer surface adhesion interaction may be carefully tuned to satisfy the following four conditions:
Adhesion (ink to imaging member)< Cohesion (ink at transfer from imaging member to intermediate transfer member); and
Adhesion (ink to imaging member)< Adhesion (ink to intermediate transfer member); and
Adhesion (ink to intermediate transfer member)< Cohesion (ink at transfer from intermediate member to image receiving medium substrate); and
Adhesion (ink to intermediate transfer member)< Adhesion (ink to image receiving medium substrate).

As indicated above, one simple manner by which to achieve the above relative force parameters in a particularly-chosen current material set may be to change the relative surface roughness between the donor surface and the receiver surface. For example, similar surface materials can be used for both the reimageable surface of the imaging member and the surface of the intermediate transfer member in the variable digital data lithographic image forming system. The imaging member may have a relatively smoother (reimageable) surface, while the intermediate transfer member may have a comparatively rougher finish.

As the proposed variable digital data lithographic image forming process continues to mature, excellent image quality for the produced output images is being achieved with a smooth reimageable surface for the imaging member with vaporized dampening fluid, and excellent release is also demonstrated with a textured (rough) surface.

System latitude may be particularly challenging for multiple ink layers, including increased concerns with back transfer at later ink transfer layers, e.g., in a third and a fourth layer of ink transfer from the imaging member to the intermediate transfer member, due to the significantly weakened ink layer cohesion because of the increased thickness. Here, it may be most appropriate to implement rheological conditioning processes between the transfers to improve the ink layer cohesion. These rheological conditioning processes may include one or more of known techniques including ultraviolet pre-curing, surface evaporation, layer heating or other like methods.

In experiments, a smooth fluorosilicone material (Nusil®, flow coated) was used as the reimageable surface for the imaging member, and a textured variant of the same fluorosilicone material (Nusil®, Agfa texture) was used as the intermediate transfer member. A particular variable digital data lithographic ink (formulation C33) was applied to the reimageable surface with an anilox roll. This combination produced nearly 100% first transfer of the ink from the reimageable surface to a surface of the intermediate transfer member, and greater than 90% second transfer from the image transfer member to Lustrogloss® paper as the image receiving medium substrate.

Advantages of the disclosed schemes include: (1) simplified use of less expensive media handling components; (2) improved color registration achieved independent of media handling adjustments and without using “trial” sheets; (3) greater system architectural flexibility with a wide array of possible intermediate configurations; and (4) isolation of each imaging member and associated subsystems comprising each imaging module from image receiving medium related damage and debris.

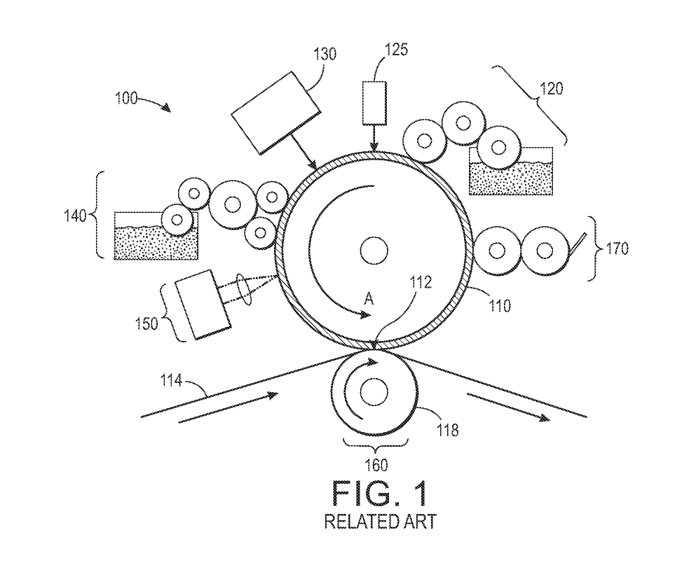

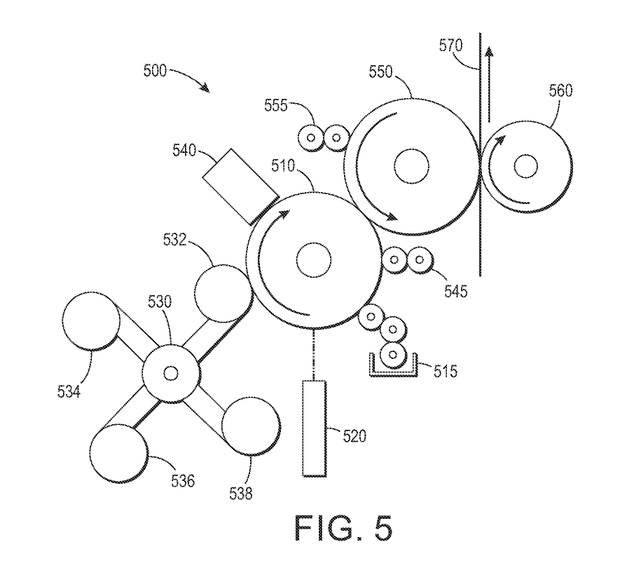

FIG. 5 illustrates an exemplary embodiment of a unique multi-color module 500 for a variable digital data lithographic system according to this disclosure. As shown in FIG. 5, in a variation of the variable digital data lithographic image forming system shown in FIG. 1, a multi-color inker 530 is provided.

According to the exemplary embodiment 500 shown in FIG. 5, an imaging member 510, with a reimageable surface may be provided. The imaging member 510 may exhibit characteristics such as those discussed above regarding the reimageable surface of the imaging member 110 in the architecture shown in FIG. 1. The reimageable surface may have structured or unstructured texture to control the quality of the dampening fluid and ink image formation, and to enable high-efficiency transfer of inked images from the reimageable surface of the imaging member to the intermediate transfer member 550. The intermediate transfer member 550 may have a relatively grainier or rougher surface to promote transfer efficiency of the successive ink layers from the reimagaeable surface of the imaging member 510.

An image formed of one or more ink layers on the intermediate transfer member 550 according to the details set forth below may be transferred to an image receiving medium substrate 570 at a transfer nip formed between the intermediate transfer member 550 and an impression roller 560. A separate intermediate transfer member cleaning unit 555 may be provided to clean residual ink and/or debris from the intermediate transfer member 550 after image transfer to the image receiving medium substrate 570 at the transfer nip. The cooperating textures of the reimageable surface of the imaging member 510, a surface of the intermediate transfer member 550 and a surface of an image receiving medium substrate 570 may enable high-efficiency in high fidelity ink transfer, e.g., in excess of 90%, from the reimageable surface of the imaging member 510 to the surface of the intermediate transfer member 550 and then, in turn, from the surface of intermediate transfer member 550 to all types of image receiving medium substrates, such as the exemplary image receiving medium substrate 570 shown in FIG. 5. Exemplary image receiving medium substrates may include, for example, coated and uncoated papers, heavy stocks, rough substrates, woods, fabrics, plastics and the like. In embodiments, the disclosed transfer efficiencies may be enhanced by controlling ink temperature prior to and/or in the transfer nip formed between the imaging member 510 and the intermediate transfer member 550. Ink temperature and pressure control at the nip may be according to known transfer methods employed for controlling ink transfer.

In operation, downstream of a transfer nip between imaging member 510 and the intermediate transfer member 550, a cleaning system 545 may be provided for cleaning residual ink and debris from the reimageable surface of the imaging member 510. A metered amount of a dampening fluid, as described above, may be applied to the reimageable surface using a dampening fluid supply and metering unit 515. An optical patterning unit 520 may produce optical patterned images in the dampening fluid bathed reimageable surface of the imaging member 510. The optical patterning unit 520 may comprise a laser patterning device for projecting laser energy onto the reimagaeable surface, according to the methods described above. As shown in FIG. 5, the optical patterning unit 520 may be positioned to pattern the reimageable surface of the imaging member downstream of the dampening fluid supply and metering unit 515 once an amount of dampening fluid has been evenly distributed on the reimageable surface of the imaging member 510 and prior to the patterned surface imaging member 510 being contacted by a multi-color inker 530, which will be described in greater detail below. A rheology (ink viscosity) control or conditioning unit 540 such as, for example, a UV partial cure unit, may be provided downstream of the a multi-color inker 530. The rheology control or conditioning unit 540 may be used to individually modify the cohesion and/or viscosity of the ink residing in the patterned reimageable surface of the imaging member 510.

The multi-color inker 530 may operate in conjunction with the imaging member 510 on multiple cycles as follows. Four inkers 532,534,536,538 may be available in the multi-color inker 530. Upon commencement of the imaging operation, the impression roller 560 may be disengaged in a manner such that no transfer nip is formed with the intermediate transfer member 550. In like manner, at this stage in the imaging operation, the intermediate transfer member cleaning unit 555 may also be disengaged so as to not contact the surface of the intermediate transfer member 550.

In a first color cycle of the imaging member 510, a first color ink supply 532 may be brought into contact engagement with the patterned reimageable surface of the imaging member 510. The first color ink will be deposited on the reimageable surface creating a first color inked image on the patterned reimageable surface. The rheology of the first color ink may be modified by the rheology control or conditioning unit 540. The first color inked image may then be transferred from the reimageable surface of the imaging member 510 to the surface of the intermediate transfer member 550 at the transfer nip formed therebetween.

In a second color cycle of the imaging member 510, a second color ink supply 534 may be brought into contact engagement with the patterned reimageable surface of the imaging member 510. The second color ink will be deposited on the reimageable surface creating a second color inked image on the patterned reimageable surface. The rheology of the second color ink may be modified by the rheology control or conditioning unit 540. The second color inked image may then be transferred from the reimageable surface of the imaging member 510 to the surface of the intermediate transfer member 550 at the transfer nip formed therebetween over the first color inked image.

In a third color cycle of the imaging member 510, a third color ink supply 536 may be brought into contact engagement with the patterned reimageable surface of the imaging member 510. The third color ink will be deposited on the reimageable surface creating a third color inked image on the patterned reimageable surface. The rheology of the third color ink may be modified by the rheology control or conditioning unit 540. The third color inked image may then be transferred from the reimageable surface of the imaging member 510 to the surface of the intermediate transfer member 550 at the transfer nip formed therebetween over the first and second color inked images.

In a fourth color cycle of the imaging member 510, a fourth color ink supply 538 may be brought into contact engagement with the patterned reimageable surface of the imaging member 510. The fourth color ink will be deposited on the reimageable surface creating a fourth color inked image on the patterned reimageable surface. The rheology of the fourth color ink may be modified by the rheology control or conditioning unit 540. The fourth color inked image may then be transferred from the reimageable surface of the imaging member 510 to the surface of the intermediate transfer member 550 at the transfer nip formed therebetween over the first, second and third color inked images.

With the four-color inked image formed on the intermediate transfer member 550 in this embodiment, the impression roller 560 may be moved to contact the intermediate transfer member 550 to form a transfer nip via which an image receiving medium substrate 570 may be conveyed for image transfer. The four-color inked image may be transferred from intermediate transfer member 550 to the image receiving medium substrate 570 at the transfer nip. The intermediate transfer member cleaning unit 555 may be moved to engage the surface of the intermediate transfer member 550 to clean any residual ink or debris from the surface of the intermediate transfer member 550.

As a trail edge of the image receiving medium substrate passes the transfer nip between the intermediate transfer member 550 and the impression roller 560, the impression roller 560 may be disengaged in preparation for a next image forming operation. As a trail edge of a residual image on the surface of the intermediate transfer member 550 passes the intermediate transfer member cleaning unit 555, the intermediate transfer member cleaning unit 555 may again be disengaged so as to not contact the surface of the intermediate transfer member 550 in preparation for the next image forming operation.

This discussion is not intended to limit multi-color inker 530 to any particular configuration or design. It should be recognized that there are many ink supply configurations as alternatives that could be proposed.

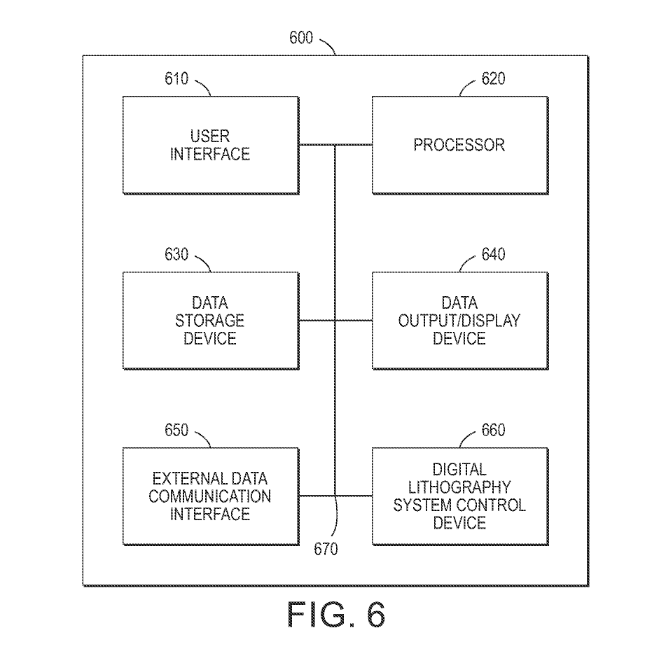

FIG. 6 illustrates a block diagram of a control system 600 for controlling characteristics and functions of variable digital data lithographic image forming according to this disclosure.

The exemplary control system 600 may include an operating interface 610 by which a user may communicate with the exemplary control system 600 for directing image forming operations, including the forming of multi-color output images, in a variable digital data lithographic image forming system such as those described above via one or more digital lithography system control devices 660. The operating interface 610 may be a locally accessible user interface associated with the image forming system, which may be configured as one or more conventional mechanisms common to control devices and/or computing devices that may permit a user to input information to the exemplary control system 600. The operating interface 610 may include, for example, a conventional keyboard, a touchscreen with “soft” buttons or with various components for use with a compatible stylus, a microphone by which a user may provide oral commands to the exemplary control system 600 to be “translated” by a voice recognition program, or other like device by which a user may communicate specific operating instructions to the exemplary control system 600. The operating interface 610 may be a part or a function of a graphical user interface (GUI) mounted on, integral to, or associated with, the image forming system with which the exemplary control system 600 is associated.

The exemplary control system 600 may include one or more local processors 620 for individually operating the exemplary control system 600 and for carrying out operating functions in the image forming system. Processor(s) 620 may include at least one conventional processor or microprocessor that interprets and executes instructions to direct specific functioning of the exemplary control system 600 and an associated image forming system.

The exemplary control system 600 may include one or more data storage devices 630. Such data storage device(s) 630 may be used to store data or operating programs to be used by the exemplary control system 600, and specifically the processor(s) 620. Data storage device(s) 630 may be used to store information regarding individual operating characteristics of the image forming and specific components for controlling the rheology of multiple ink layers that may be used to form an output image from the image forming system. These stored schemes may control all operations of the image forming system. The data storage device(s) 630 may include a random access memory (RAM) or another type of dynamic storage device that is capable of storing updatable database information, and for separately storing instructions for execution of system operations by, for example, processor(s) 620. Data storage device(s) 630 may also include a read-only memory (ROM), which may include a conventional ROM device or another type of static storage device that stores static information and instructions for processor(s) 620. Further, the data storage device(s) 630 may be integral to the exemplary control system 600, or may be provided external to, and in wired or wireless communication with, the exemplary control system 600.

The exemplary control system 600 may include at least one data output/display device 640, which may be configured as one or more conventional mechanisms that output information to a user, including, but not limited to, a display screen on a GUI of the image forming system with which the exemplary control system 600 may be associated. The data output/display device 640 may be used to indicate to a user a status of an image forming operation in the image forming system.

Where appropriate, the exemplary control system 600 may include at least one external data communication interface 650 by which the exemplary control system may communicate with the image forming system when the exemplary control system 600 is mounted remotely from, and in wired or wireless communication with, the associated image forming system.

All of the various components of the exemplary control system 600, as depicted in FIG. 6, may be connected internally, and to the image forming system, by one or more data/control busses 670. These data/control busses 670 may provide wired or wireless communication between the various components of the exemplary control system 600, whether all of those components are housed integrally in, or are otherwise external and connected to, other components of the image forming system with which the exemplary control system 600 may be associated.

It should be appreciated that, although depicted in FIG. 6 as an essentially integral unit, the various disclosed elements of the exemplary control system 600 may be arranged in any combination of sub-systems as individual components or combinations of components, integral to a single unit, or external to, and in wired or wireless communication with, the single unit of the exemplary control system 600. In other words, no specific configuration as an integral unit or as a support unit is to be implied by the depiction in FIG. 6. Further, although depicted as individual units for ease of understanding of the details provided in this disclosure regarding the exemplary control system 600, it should be understood that the described functions of any of the individually-depicted components may be undertaken, for example, by one or more processors 620 connected to, and in communication with, one or more data storage device(s) 630, all of which support operations in the associated image forming system.

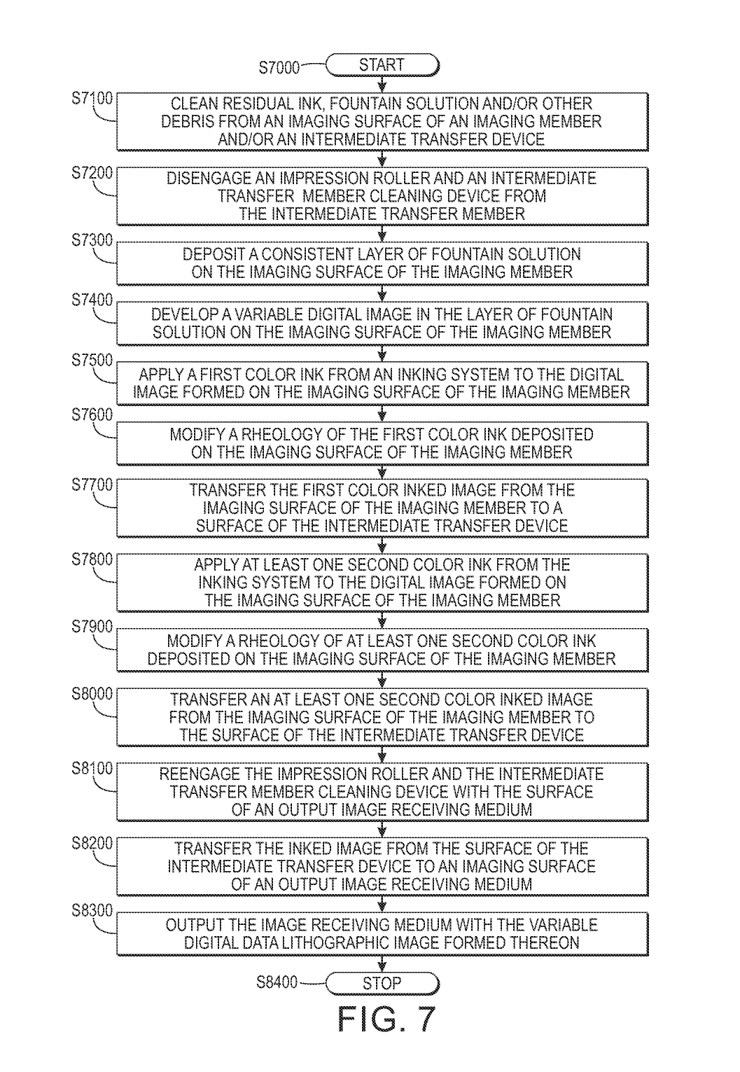

The disclosed embodiments may include methods for controlling characteristics and functions of variable digital data lithographic image forming. FIG. 7 illustrates a flowchart of such an exemplary method. As shown in FIG. 7, operation of the method commences at Step S7000 and proceeds to Step S7100.

In Step S7100, residual ink, dampening fluid and/or other debris may be removed from surfaces of the imaging member and the intermediate transfer member in preparation for a variable digital data lithographic image forming cycle in a variable digital data offset lithographic image forming system. Operation of the method proceeds to Step S7200.

In Step S7200, an impression roller and an intermediate transfer member cleaning unit may be disengaged from the intermediate transfer member to prepare the intermediate transfer member to receive multiple colors of ink in layers. Operation of the method proceeds to Step S7300.

In Step S7300, a consistent layer of dampening fluid may be deposited on the imaging surface of the imaging member. Operation of the method proceeds to Step S7400.

In Step S7400, a digital image may be developed in the layer of dampening fluid deposited on the imaging surface of the imaging member using an optical imaging device such as a laser imaging device. Operation of the method proceeds to Step S7500.

In Step S7500, a first color ink layer may be applied to the developed dampening fluid layer digital image on the imaging surface of the imaging member from a multiple color inking system. Operation of the method proceeds to Step S7600.

In Step S7600, the rheology (viscosity or cohesion) of the first color ink layer forming the first color inked image on the imaging surface of the imaging member may be modified by using, for example, a rheology adjusting system that may pre-condition or partially cure the deposited first color ink layer in a manner that will aid in maximizing the ink transfer efficiency from the imaging member to the intermediate transfer member. Operation of the method proceeds to Step S7700.

In Step S7700, the first color inked image may be transferred from the imaging surface of the imaging member to the intermediate transfer member. Operation of the method proceeds to Step S7800.

In Step S7800, at least one second color ink layer may be applied to the developed dampening fluid digital image on the imaging surface of the imaging member from a multiple color inking system. Operation of the method proceeds to Step S7900.

In Step S7900, the rheology of the at least one second color ink layer forming the at least one second color inked image on the imaging surface of the imaging member may be modified, as above. Operation of the method proceeds to Step S8000.

In Step S8000, the at least one second color inked image may be transferred from the imaging surface of the imaging member to the intermediate transfer member over the previously transferred first color inked image.

Transfer of subsequent colors of inks to form separate color inked images on the intermediate transfer member may be completed in the manner outlined above until all available color inked images are deposited in layers on the intermediate transfer member. Operation of the method proceeds to Step S8100.

In Step S8100, the impression roller and the intermediate transfer member cleaning unit may be reengaged with the surface of the intermediate transfer member to form transfer and cleaning nips, respectively. Operation of the method proceeds to Step S8200.

In Step S8200, the multiple color inked image formed on the surface of the image transfer member may be transferred to an output image receiving medium at the transfer nip formed between the intermediate transfer member and the impression roller. Operation of the method proceeds to Step S8300.

In Step S8300, the image receiving medium substrate, with the variable digital data lithographic image formed thereon, may be output from the image forming system. Operation of the method proceeds to Step S8400, where operation of the method ceases.

The above-described exemplary systems and methods reference certain conventional components to provide a brief, general description of suitable image forming means by which to carry out variable digital data lithographic image forming. Those skilled in the art will appreciate that other embodiments of the disclosed subject matter may be practiced with many types of image forming elements common to lithographic image forming systems in many different configurations.

The exemplary depicted sequence of executable instructions represents one example of a corresponding sequence of acts for implementing the functions described in the steps. The exemplary depicted steps may be executed in any reasonable order to carry into effect the objectives of the disclosed embodiments. No particular order to the disclosed steps of the method is necessarily implied by the depiction in FIG. 7, and the accompanying description, except where a particular method step is a necessary precondition to execution of any other method step. Individual method steps may be carried out in sequence or in parallel in simultaneous or near simultaneous timing.

Although the above description may contain specific details, they should not be construed as limiting the claims in any way. Other configurations of the described embodiments of the disclosed systems and methods are part of the scope of this disclosure.

It will be appreciated that a variety of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method for managing ink transfer in a variable digital data lithographic image forming device, comprising:
cleaning a digitally reproducible imaging surface in the image forming device with a first cleaning device between imaging operations;
cleaning at least one intermediate image transfer surface in the image forming device with a second cleaning device between the imaging operations, the second cleaning device being a different cleaning device from the first cleaning device, the at least one intermediate image transfer surface being a surface to which an inked image is transferred from the digitally reproducible imaging surface before being transferred to an output image receiving medium substrate in the imaging operations;
dampening the digitally reproducible imaging surface with a layer of dampening fluid;
forming a digital pattern in the layer of dampening fluid on the digitally reproducible imaging surface;
inking the digital pattern formed on the digitally reproducible imaging surface with a first color ink to produce a first color inked image;
transferring the first color inked image from the digitally reproducible imaging surface to the at least one intermediate image transfer surface;
cleaning residual first color ink from the digitally reproducible imaging surface;
inking the digital pattern formed on the digitally reproducible imaging surface with at least one second color ink to produce at least a second color inked image;
transferring the at least the second color inked image from the digitally reproducible imaging surface to the at least one intermediate image transfer surface to form a multi-color inked image;
transferring the multi-color inked image from the at least one intermediate image transfer surface to the output image receiving medium substrate at an image transfer nip formed between the at least one intermediate image transfer surface and an opposing impression roller; and
outputting the output image receiving medium substrate with the multi-color inked imaged formed thereon from the image forming device.

2. The method of claim 1, the digitally reproducible imaging surface being patterned with a different digital image between the imaging operations.

3. The method of claim 1, further comprising disengaging the opposing impression cylinder from contact with the at least one intermediate image transfer surface to open the image transfer nip while forming the multi-color inked image on the at least one intermediate image transfer surface.

4. The method of claim 3, further comprising reengaging the opposing impression cylinder into contact with the at least one intermediate image transfer surface after forming the multi-color inked image on the at least one intermediate image transfer surface to close the image transfer nip for transferring the multi-color inked from the at least one intermediate image transfer surface to the image receiving medium substrate.

5. The method of claim 1, further comprising disengaging the second cleaning device from contact with the at least one intermediate image transfer surface to open a cleaning nip while forming the multi-color inked image on the at least one intermediate image transfer surface.

6. The method of claim 5, further comprising reengaging the second cleaning device into contact with the at least one intermediate image transfer surface after transferring the multi-color inked from the at least one intermediate image transfer surface to the image receiving medium substrate at the image transfer nip.

7. The method of claim 1, the inking of the digital pattern formed on the digitally reproducible imaging surface being accomplished by an inking device that comprises multiple ink supply units that are separately brought into contact with the digital pattern formed on the digitally reproducible imaging surface on separate cycles of the digitally reproducible imaging surface past the inking device.

8. The method of claim 1, further comprising modifying a rheology of the first color ink disposed on the digital pattern formed on the digitally reproducible imaging surface to increase a transfer efficiency of the first color ink from the digitally reproducible imaging surface to the at least one intermediate image transfer surface.

9. The method of claim 8, the transfer efficiency being increased to in excess of ninety percent.

10. The method of claim 8, the rheology of the first color ink being modified to satisfy a predetermined relationship, the predetermined relationship being expressed according to the following:
a first adhesion force between the first ink and the digitally reproducible imaging surface being less than a second adhesion force between the first ink and the at least one intermediate image transfer surface; and
the first adhesion force between the first ink and the digitally reproducible imaging surface being less than a first cohesion force of the first ink.

11. The method of claim 1, further comprising modifying a rheology of the at least one second color ink disposed on the digital pattern formed on the digitally reproducible imaging surface to increase a transfer efficiency of the at least one second color ink from the digitally reproducible imaging surface to a layer of the first color ink disposed on the at least one intermediate image transfer surface.

12. The method of claim 11, the rheology of the at least one second color ink being modified to satisfy a predetermined relationship, the predetermined relationship being expressed according to the following:
a third adhesion force between the at least one second color ink and the digitally reproducible imaging surface being less than a second cohesion force of the at least one second color ink;
the third adhesion force between the at least one second color ink and the digitally reproducible imaging surface being less than a fourth adhesion force between the at least one second color ink and the layer of the first color ink disposed on the at least one intermediate image transfer surface;
the third adhesion force between the at least one second color ink and the digitally reproducible imaging surface being less than a first cohesion force of the layer of the first color ink disposed on the at least one intermediate image transfer surface; and
the third adhesion force between the at least one second color ink and the digitally reproducible imaging surface being less than a second adhesion force between the first ink and the at least one intermediate image transfer surface.

13. A managed ink transfer variable digital data lithographic image forming device, comprising:
a digitally reproducible imaging surface that is patterned with a different digital image between imaging operations;
a first cleaning device that cleans the digitally reproducible imaging surface in the image forming device between the imaging operations;
at least one intermediate image transfer surface to which an inked image is transferred from the digitally reproducible imaging surface before being transferred to an output image receiving substrate in the imaging operations;
a second cleaning device that cleans the at least one intermediate image transfer surface in the image forming device between the imaging operations, the second cleaning device being a different cleaning device from the first cleaning device;
a dampening device that dampens the digitally reproducible imaging surface with a layer of dampening fluid;
an optical digital patterning device that forms a digital pattern in the layer of dampening fluid on the digitally reproducible imaging surface;
a multi-color inking device that inks the digital pattern formed on the digitally reproducible imaging surface with a first color ink on a first cycle of the digitally reproducible imaging surface to produce a first color inked image and that inks the digital pattern formed on the digitally reproducible imaging surface with at least one second color ink on a second and subsequent cycles of the digitally reproducible imaging surface to produce at least a second color inked image,
wherein:
the first color inked image is transferred from the digitally reproducible imaging surface to the at least one intermediate image transfer surface on the first cycle of the digitally reproducible imaging surface,
the first cleaning device cleans residual first color ink from the digitally reproducible imaging surface,
the at least one second color ink is transferred from the digitally reproducible imaging surface to the at least one intermediate image transfer surface to form a multi-color inked image,
the multi-color inked image is transferred from the at least one intermediate image transfer surface to an image receiving medium substrate at an image transfer nip formed between the at least one intermediate image transfer surface and an opposing impression roller, and
the image receiving medium substrate with the multi-color inked imaged formed thereon is output from the image forming device.

14. The managed ink transfer variable digital data lithographic image forming device of claim 13, wherein the opposing impression cylinder is movable between a first position in contact with the at least one intermediate image transfer surface to form the image transfer nip and a second position that disengages the impression cylinder from contact with the at least one intermediate image transfer surface to open the image transfer nip while forming the multi-color inked image on the at least one intermediate image transfer surface.

15. The managed ink transfer variable digital data lithographic image forming device of claim 14, the opposing impression cylinder being moved to the first position in contact with the at least one intermediate image transfer surface after forming the multi-color inked image on the at least one intermediate image transfer surface to close the image transfer nip for transferring the multi-color inked from the at least one intermediate image transfer surface to the image receiving medium substrate.

16. The managed ink transfer variable digital data lithographic image forming device of claim 13, wherein the second cleaning device is movable between a first position in contact with the at least one intermediate image transfer surface to form a cleaning nip and a second position that disengages the second cleaning device from contact with the at least one intermediate image transfer surface to open the cleaning nip while forming the multi-color inked image on the at least one intermediate image transfer surface.

17. The managed ink transfer variable digital data lithographic image forming device of claim 16, the second cleaning device being moved to the first position in contact with the at least one intermediate image transfer surface after transferring the multi-color inked from the at least one intermediate image transfer surface to the image receiving medium substrate at the image transfer nip.

18. The managed ink transfer variable digital data lithographic image forming device of claim 13, the multi-color inking device inking the digital pattern formed on the digitally reproducible imaging surface with sequentially introduced multiple ink supply units that are separately brought into contact with the digital pattern formed on the digitally reproducible imaging surface on separate cycles of the digitally reproducible imaging surface past the multi-color inking device.

19. The managed ink transfer variable digital data lithographic image forming device of claim 13, further comprising a rheology modifying unit that modifies a rheology of the first color ink disposed on the digital pattern formed on the digitally reproducible imaging surface to increase a transfer efficiency of the first color ink from the digitally reproducible imaging surface to the at least one intermediate image transfer surface.

20. The managed ink transfer variable digital data lithographic image forming device of claim 19, the rheology modifying unit modifying the rheology of the first color ink to increase the transfer efficiency of the first color ink to in excess of ninety percent.

21. The managed ink transfer variable digital data lithographic image forming device of claim 19, the rheology modifying unit modifying the rheology of the first color ink to satisfy a predetermined relationship, the predetermined relationship being expressed according to the following:
a first adhesion force between the first ink and the digitally reproducible imaging surface being less than a second adhesion force between the first ink and the at least one intermediate image transfer surface; and
the first adhesion force between the first ink and the digitally reproducible imaging surface being less than a first cohesion force of the first ink.

22. The managed ink transfer variable digital data lithographic image forming device of claim 13, the rheology modifying unit modifying the rheology of the at least one second color ink disposed on the digital pattern formed on the digitally reproducible imaging surface to increase a transfer efficiency of the at least one second color ink from the digitally reproducible imaging surface to a layer of the first color ink disposed on the at least one intermediate image transfer surface.

23. The managed ink transfer variable digital data lithographic image forming device of claim 22, the rheology modifying unit modifying the rheology of the at least one second color ink to satisfy a predetermined relationship, the predetermined relationship being expressed according to the following:
a third adhesion force between the at least one second color ink and the digitally reproducible imaging surface being less than a second cohesion force of the at least one second color ink;
the third adhesion force between the at least one second color ink and the digitally reproducible imaging surface being less than a fourth adhesion force between the at least one second color ink and the layer of the first color ink disposed on the at least one intermediate image transfer surface;
the third adhesion force between the at least one second color ink and the digitally reproducible imaging surface being less than a first cohesion force of the layer of the first color ink disposed on the at least one intermediate image transfer surface; and
the third adhesion force between the at least one second color ink and the digitally reproducible imaging surface being less than a second adhesion force between the first ink and the at least one intermediate image transfer surface.
